(19) United States
(12) Patent Application Publication
(10) Pub. No.: US 2007/0280213 A1
(43) Pub. Date: Dec. 6, 2007

(54) Location verification for VOIP service provider

(75) Inventors: Manoj Sindhwani, Oak Hill, VA (US); Brian Glinsman, Oak Hill, VA (US)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 11/444,752

(22) Filed: May 31, 2006

(51) Int. Cl. H04L 12/66

(52) U.S. Cl. 370/356

(57) ABSTRACT

A method and system is provided for to keep a VOIP provider updated with a subscriber's physical location information whether the subscriber is using the IP phone for the first time or has moved the VOIP device away from the original subscription location. The VOIP device denies service until the subscriber has specified his or her updated location.

### CROSS-REFERENCE TO RELATED APPLICATIONS

None

### FIELD OF THE INVENTION

The present invention relates to providing voice over Internet Protocol (VOIP) providers a way of updating customer location information to meet E911 requirements.

### BACKGROUND OF THE INVENTION

The emergency “911” service began in 1965 as a result of cooperation between the Federal Communications Commission (FCC), telecommunications industry, and state regulators. Enhanced 911 (E911) began on wireline phone systems and includes the ability for the call center to collect caller-ID and location information from a caller during an emergency. Telecoms are able to provide this information for wireline phones, however wireless cellular phones and phones using Internet protocol (IP) technology, called voice over IP (VOIP) present new challenges for the E911 system. In 1995 the FCC issued order FCC 05-116. Chairman Martin issued a first order and notice of rulemaking to require VOIP providers to incorporate 911 emergency services into their systems that works similar to traditional phone service. He stated that currently, there are many VOIP providers that either do not provide their customers with any access to 911 emergency services or only provide 911 access in certain areas of the country.

The order adopted by the FCC states that 911 services must be provided as a standard feature on every VOIP line. VOIP providers must provide E911 call features such as call back numbers and customer location information to the emergency operator and a must provide the customer a means of updating this information, whether he or she is at home or away from home.

Federal regulations, Fed. Reg. Vol. 70, no 124 (Jun. 29, 2005) state “we require, within 120 days of the effective date of this Order, an interconnected VoIP provider must transmit all 911 calls, as well as a call back number and the caller's “Registered Location” for each call, to the PSAP [Public Safety Answering Point], designated statewide default answering point, or appropriate local emergency authority that serves the caller's Registered Location and that has been designated for telecommunications carriers under section 64.3001 of the Commission's rules. These calls must be routed through the use of ANI and, if necessary, pseudo-ANI, via the dedicated Wireline E911 Network, and the Registered Location must be available from or through the ALI Database. [H]owever, an interconnected VoIP provider need only provide such call back and location information as a PSAP, designated statewide default answering point, or appropriate local emergency authority is capable of receiving and utilizing.”

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed.

An example of networks and components for a VOIP call is illustrated in FIG. 1. In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved. In a packet network, a message to be sent is divided into separate blocks of data packets that are the same or variable lengths. The packets are transmitted over a packet network and can pass through multiple servers or routers. The packets are then reassembled at a receiver before the payload, or data within the packets, is extracted and reassembled for use by the receiver's computer. To ensure the proper transmission and re-assembly of the data at the receiving end, the packets contain a header which is appended to each packet and contains control data and sequence verification data so that each packet is counted and re-assembled in a proper order. A variety of protocols are used for the transmission of packets through a network. Over the Internet and many local packet-switched networks the Transport Control Protocol/Internet Protocol (TCP/IP) suite of protocols is used to manage transmission of packets.

A wired network can include a WLAN (Wireless Local Area Network) leg. WLANs utilize RF (Radio Frequency) signals or light signals to connect mobile endpoints to each other or to a centralized gateway and transmit data over a wireless medium between the physical endpoints or between a mobile endpoint and an endpoint on a network that is connected to the WLAN. In 1997 the IEEE published standards for one type of WLAN under the title of 802.11 (also known as “Wi-Fi”). Currently, most of these networks are used for data access from laptop computers and personal digital assistants (PDAs). The basic hardware setup of an IEEE 802.11 network is the Basic Service Set (BSS), which is merely a number of endpoint stations that communicate with one another. In a BSS, IEEE 802.11 enables wireless mobile stations (STAs) to communicate through a wireless network interface directly with each other or with other stations through an access point. An access point (AP) is a centralized gateway providing message and power management and access to an external LAN (Local Area Network) and/or the Internet. An ESS is larger than a BSS and can be a combination of BSSs or a BSS and other associated network nodes, components, and LAN lines. An Independent Basic Service Set (IBSS), also called “ad-hoc” is merely a single BSS where two mobile STAs can communication with one another without the need for a master STA or AP.

An example of a multimedia network capable of transmitting a VOIP call or real-time video is illustrated in FIG. 1. The diagram illustrates a network 10 that could include managed LANs and WLANs accessing the Internet or other Broadband Network 18 such as an packet network with IP protocols, Asynchronous Transfer Mode (ATM), frame relay, or Ethernet. Network 10 includes many comments that are connected with devices generally known as “nodes.” Nodes include switches, routers, access points, servers, and end-points such as user's computers and telephones. The network 10 includes a media gateway 22 connected between broadband network 18 and IP phone 31. On the other end, a residential media gateway 12 is connected to broadband network 18 and wireless access point (AP) 20. AP 20 includes private wireless LANs (WLANs) and “hotspots,” that use “Wi-Fi” wireless network technology available for public use at retail establishments and commercial areas. AP 20 is connected between gateway 12 and wireless IP phone (WIPP) 16, however, in many applications AP 20 is connected directly to broadband network 18. WIPP 16 functions as a portable phone that connects to the broadband network 18 via AP 20 and can include VOIP call and service features present on any typical IP phone. Gateway 12 may also connect a traditional analog phone 14 to broadband network 18 to place IP calls to other phones on the network using gateway 20 as the point of VOIP functionality. Further, IP phone 34 may include VOIP functionality in the phone itself with need only of a router 32 for a broadband network 18 connection. A VOIP call may be placed between IP phone 34 and wireless IP phone 16 using appropriate soft IP phone service ware that facilitates the call. In this call, voice signals and associated control packet data are sent in a real-time media stream between IP phone 34 and WIPP 16.

A voice call may be placed between WIPP 16 to remote analog phone 31 through the Publicly Switched Telephone Network (PSTN) 28 and central office 30. PSTN is also connected to broadband network 18 through a trunk gateway system that has components signal gateway 24, media gateway controller/proxy (MGC) 22, and trunk media gateway (MG) 26. IP and packet data (e.g., real time protocol) associated with the call is routed between media gateway 12 and trunk MG 26. A signaling component in MG 24 translates between VOIP signaling and PSTN 28 signaling to provide a mechanism to transport endband signaling, such as tones, over a packet network in a reliable fashion. A media gateway controller 22 is the controlling operator for the trunk GW 26 and signaling gateway 24, responsible for processing protocol messages, security and user authentication, and monitoring processing resources. The trunk gateway system provides real-time two-way communications interfaces between the IP broadband network 18 and the PSTN 28.

A media gateway for residential and commercial applications is a bearer of network traffic and signaling interworking between the PSTN and VoIP. MG 12 uses VoIP for transmitting and receiving voice calls and is connected to broadband network 18 that may include the Internet. Access to the Internet from MG may be provided via cable modem, DSL (digital subscriber line) modem, high speed fiber network, frame relay access network, Internet backbone, etc. The media gateway also provides the service of mapping and translating functions and protocols between VoIP and traditional/conventional telephony devices, such as analog phone 16. Services performed by MG 12 include voice compression, tone generation, tone detection, delay and jitter compensation, PLC, signaling mapping for PSTN subscriber signaling and VoIP signaling, echo cancellation, and packet media termination for packets coming from broadband network 18 since packets are not used in the analog side of the MG. MG 12 reverses its operations for voice signals originating in analog equipment; it takes analog signals from a subscriber telephone, converts them to packets, and transmits the packets across IP network 18.

A voice call may be placed between WIPP 16 to remote analog phone 31 through the PSTN 28 and central office 30. PSTN is also connected to IP network 18 through a trunk gateway system that has components signal gateway 24, media gateway controller/proxy (MGC) 22, and trunk media gateway (MG) 26. IP and packet data (e.g., real time protocol) associated with the call is routed between RGW 12 and trunk MG 26. The trunk gateway system provides real-time two-way communications interfaces between the broadband network 18 and the PSTN 28.

There are numerous problems associated with including E911 services as a standard features for VOIP service. VOIP providers transmit calls through computer networks instead of the PSTN. Networks can include the Internet and numerous WANs and LANs throughout the nation. VOIP gateways and phones do not have a physical location identifier, instead they use a digital network address such as an IP address. VOIP phones can have phone numbers that are associated with the phone itself, and therefore the phone can be plugged in anywhere on network accessing the service provider and the phone will work. Obviously, 911 call centers have no way of knowing the exact, or even approximate, physical location of the VOIP phone solely based on the network address.

What is needed is a way for VOIP providers to update their subscribers' location information for IP phones in order to meet E911 regulations and goals setout from the FCC.

### SUMMARY OF THE INVENTION

The preferred and alternative embodiments provide a way to keep a VOIP provider (VP) updated with a subscriber's physical location information whether the subscriber is using a VOIP device for the first time or has moved the VOIP device away from the original subscription location. The reference to a “VOIP device” includes devices for connecting to a network 18 that provide telephony transmissions and services over a data network. VOIP devices include an IP phone, a Wi-Fi wireless IP (WIPP) phone, a PC-based soft client, VOIP-enabled cordless phones, Internet Access Devices (IADs), a VOIP-enabled terminal adapter (TA), VOIP-enabled router, VOIP-enabled wireless LAN gateway, among others known in the art. The VOIP device denies service until the subscriber has updated or verified his or her physical location. Updating may be performed through the provider's customer service operator or a written communication such as an Internet Web site. Once the subscriber's information is provided, the VOIP device can then be notified by the VP that the physical location information is available.

The preferred embodiment includes using the VOIP device's network address identification as a part of determining whether the device has been moved to a different physical location. The address identification includes an IP Address of the device, IP address of a gateway for the device, a DNS Address, or any other type of network address as known in the art. For explanation of the embodiments, a device's IP address will be referenced. The embodiments control the VOIP device to save its current IP address into memory. A change in IP address can be an indication of a change in network connection, which can be an indication of a physical movement of a device to a different geographic location. The device determines on its own an indication of whether it has been physically moved by finding if a current IP address is different than the last saved IP address. Upon detection of a change, the VP or the device can transmit a message to the phone to notify the user that he or she needs to update the physical address with the service provider.

The message transmitted to the user's phone can be of various types, such as the VOIP device sending a command to play a special ringer on the handset, playing an announcement on the user's handset indicating that the user needs to update the location information, playing a special dial tone to that the user needs to update the information, and a VBD message such as caller-ID text to the phone's display screen. A device such as an IP phone that incorporates an screen such as an LCD (Liquid Crystal Display) screen to display calling and service information could also display a message indicating a reason for lack of service.

The message can either prompt the user to specify via the use of DTMF (Dual-Tone Multi-Frequency) digit that the current location information has not changed and is still accurate or that the user can update the location information, else the device can connect the user to customer care agent so that the location can be updated. A device with an LCD screen could provide a soft-key feature on the screen for the user to respond to the service message. The message can also be an audible announcement or other signal when a non-updated VOIP device goes off-hook. If a user responds that the current location information is not accurate, then VOIP service is stopped for the device. The user is then connected to the VP customer service or other service that can update the user's location information. The service is restored when notification is received from the VP that the user's location information is up-to-date.

### BRIEF DESCRIPTION OF THE DRAWINGS

For a better understanding of the nature of the present invention, its features and advantages, the subsequent detailed description is presented in connection with accompanying drawings in which:

FIG. 1 is a network diagram of a Voice Over IP network;

FIG. 2 is a flowchart comprising the preferred method for a new subscriber of a VOIP service; and

FIG. 3 is a flowchart comprising the preferred and alternative methods for a VOIP device that has changed locations.

### DETAILED DESCRIPTION OF THE INVENTION

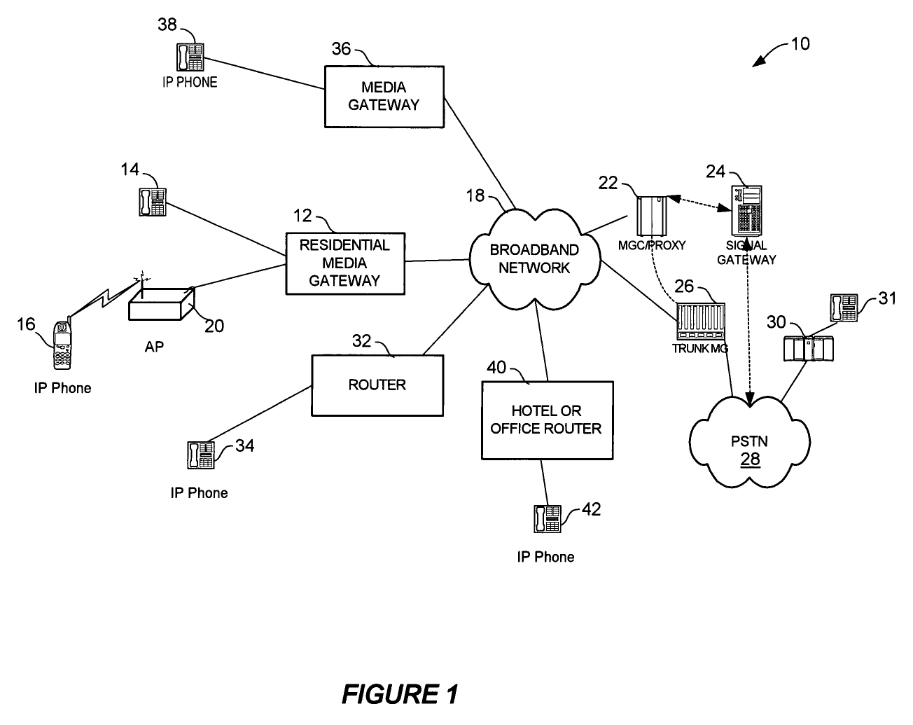

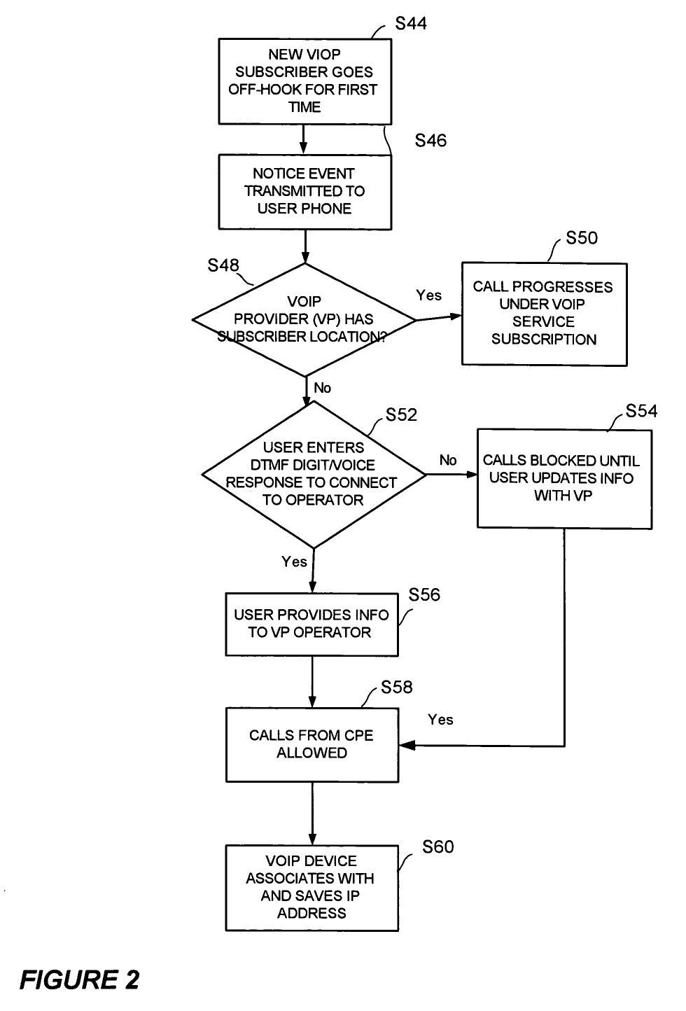

Referring again to FIG. 1, when a user with residential media gateway 12 first subscribes to service with a VOIP provider (VP), the user should have already given the VP the physical location of the VOIP device 12 corresponding to a street address or other geographic identifying location for emergency services. However, to meet E911 regulations, the provider can not be sure that the address used in the initial subscription application is the same address as a current location for an installed VOIP device. FIG. 2 represents steps that a provider can implement for a first-time subscriber to insure that the VOIP device's current location is the same as the location information on record with the provider.

When a subscriber buys a new service, the service provider can insure that it does not enable the service before initial location has been provided and verified by the subscriber. The VOIP device 12 subscribes for a notification, which could be under appropriate protocols such as the SIP Subscribe/Notify method. When a new provider goes off-hook for the first time S44 the VOIP device detects that no initial location information has been provided and transmits S46 a notice event to the users phone. Alternatively, the event could be transmitted by the SP to the phone.

The event S46 can result from different media and technical transmissions. Preferably, the event is announcement that plays on the telephone handset that indicates the reason for lack of service. The announcement can play the user's current location information on file. If the VOIP provider has the correct subscriber information S48, then the subscriber may press a DTMF digit or give a verbal response such as “yes” that is understood by voice recognition in the VOIP device and the call progresses S50 normally under the VOIP subscription service. If the provider does not have subscriber location information or if the subscriber presses a DTMF digit or gives a “no” verbal response S48, then the method proceeds to the next decision block S52. At this point, the announcement S46 plays on the phone indicating the reason for no service and queries the user to enter a DTMF digit or give a verbal response S52 to connect the user to an operator. Alternatively, the user may be notified of an Internet Web address where the user may enter the location information. If no response is given at S52 or the user selects not to enter location information, then the VOIP device blocks S54 all calls except to the provider's customer care service until the user updates the device's location information with the VOIP provider.

Alternatively, emergency calls to 911 and direct police, fire, and ambulance numbers continue to be handled so as not to cut off a user entirely from contacting emergency services. Once the user either contacts the provider by phone or by Internet, calls from the VOIP device are allowed S58 as under the subscription S60.

At step S52, if the user selects a DTMF digit, for example by pressing “1” on a phonepad, the user is directly connected to the VP operator S56 so that the location information for the VOIP device can be provided. After the VP updates its E911 database, the provider sends an event message to the customer's VOIP device that allows the user to obtain a dial tone and place calls S58 under the user's subscription service. The reference to a “VOIP device” includes devices for connecting to a network 18 that provide telephony transmissions and services over a data network. VOIP devices include an IP phone, a Wi-Fi wireless IP phone, a PC-based soft client, VOIP-enabled cordless phones, Internet Access Devices (IADs), a VOIP-enabled terminal adapter (TA), VOIP-enabled router, VOIP-enabled wireless LAN gateway, among others known in the art.

The VOIP device also associates S60 the location information and VP confirmation with the network address of the device. This can include any type of network addresses known in the art such as IP address, DNS address, etc. However, for purposes of describing the preferred and alternative embodiments, an IP address of a device is used. Further, because many VOIP devices are behind a NAT (Network Address Translation) address, the home gateway can use many different available mechanisms known in the art to obtain the IP address of the home router. If a device can not obtain its routable IP address, then the device can use its local “NATted” IP address or equivalent. Mechanisms also include universal plug and play (UPNP) and trace route. The IP address and location information is then saved in memory residing in the VOIP device and may also be transmitted to the VP for saving in memory.

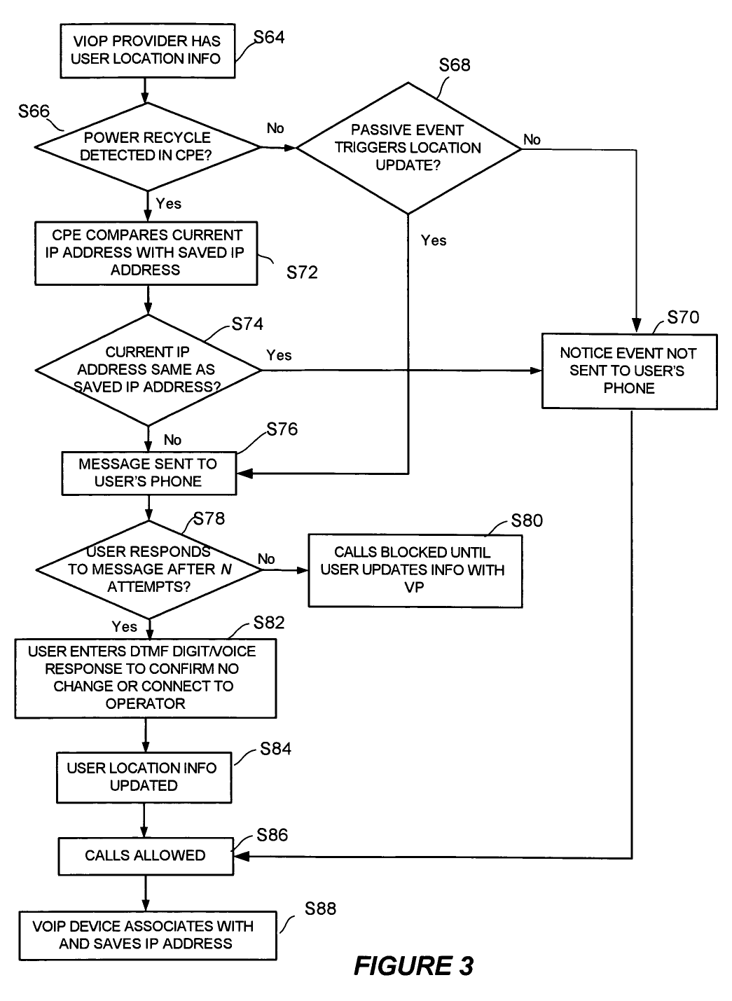

Referring to FIG. 3, a primary problem occurs with VOIP service after a user has established service and provided location information for the VOIP device S62 and then the user moves the device to a different physical location such as a different street address, different suite or floor of an office building, or different building of a campus. A user connected through MG 12 or router 32 with phone 34 may move to a different home on a different network connection at 36 with phone 38 that connects to broadband network 18. Alternatively, the user may take phone 34 to a hotel or business 40 and use as phone 42 on a different network connection. Even though the same device is used at the different locations, for E911 purposes the user's location needs to be updated with the VOIP provider. The preferred and alternative embodiments provide a mechanism to insure that the user updates the location information of the device.

A preferred method to use as an initial prompt to query the user for updated information is to detect a power recycle (e.g., on/off/on) of the VOIP device S66. Although this may be an indication of merely a power failure, it could also indicate the device was turned off and moved to a new geographic location. Whenever a power recycle is detected S66 in the VOIP device, the device detects the current routable IP address using steps in S60 and compares S72 with the saved IP address in the device. As a default mechanism, if no power recycle events are detected S66 after a certain amount of time or use S66, a passive event will trigger a query to update or verify S68 the user's location. When no passive event is triggered S70, such as time or minutes used, then calls are allowed S86 as normal and the user continues to use the subscription service.

In step S74, if the current IP address is the same as S74 the saved IP address in the VOIP device, then no notice event is transmitted S70 to the user and calls proceed as normal S86. This avoids interrupting the user with repeated and unnecessary messages asking for updated location information when all that may have occurred at the location are power outages due to weather, blackouts, or electrical service maintenance. However, if the current IP address is not the same as the saved IP address S74, or alternatively does not match a list or a range of saved IP addresses in the device, then a notice event message is sent S76 to the user's handset by the VOIP device or alternatively could come from the VP.

The message transmitted to the user's phone can be of various types. Preferably, the VOIP device sends a command to play a special ringer on the user's phone to notify the user that he or she needs to update the location information. Alternatively, when the user goes off-hook at the new location, and no new notification has been received by the VP indicating location update, the VOIP device can play an announcement on the user's telephone indicating that the user needs to update the location information. As a further alternative, the device could play a special dial tone to that the user needs to update the information. As a further alternative, the VOIP device may also transmit a message using VBD protocol, such as caller-ID, to the user's phone for display on the phone's display screen. A device such as an IP phone that incorporates or has an external LCD (Liquid Crystal Display) screen or equivalent to display calling and service information could also display a message indicating a reason for lack of service. The display can be used to show current location information and update requests similar to using voice announcements. The text message can repeat the same verbal announcement, i.e. that the user needs to verify or update the phone's location information because the IP address has changed. After the message is delivered, the user may be provided S78 with a number N of chances to respond prior to blocking calls S80 from the phone.

A default number of chances is one chance, but a reasonable number may be two or three chances in order to provide convenience to the user, who may be installing the phone in a different location and requires a few attempts to correct the location information, while protecting the VP's need to update its E911 databases with the new user contact information. A user that fails to response to the message S76 or fails to provide the new location information has the calls blocked S80 from the VOIP device. The user must then either contact the VP operator again or enter the updated information on an Internet Web site in order for service to be restored to the phone.

In step S82, the user may enter a DTMF digit or a verbal response that confirms either no change in location has actually occurred, such as in the case of a user changing the Internet service provider (ISP) for the VOIP device. Alternatively, a dedicated key such as a DTMF digit or verbal response is provided by the user that connects the user to the VP operator so that the updated location information can be given to the VP's customer care center. If a device has a touch-sensitive LCD screen, then a soft key could be provided for the same function. Once the user's location information is updated S84, the VP provides service to the VOIP device again and calls are allowed S86 under the user's subscription. After receiving a confirmation message in SIP or equivalent protocol from the VP, the VOIP device saves S88 the new IP address and location information to memory.

The present invention provides VOIP service providers a mechanism to maintain a database of a user's current physical location no matter where the device is connected to the broadband network 18. The embodiments place the burden on the user to update his or her own IP phone location information for E911 purposes. By using a change of IP address as an indicator of movement of the VOIP device to a different location, the embodiments avoid annoying users with unnecessary interruptions in service or repeated queries to update information because of power outages or moving a VOIP device around the same house or office where the IP address remains the same.

One skilled in the art will appreciate that the present invention can be practiced by other than the described embodiments, which are presented for purposes of illustration and not limitation, and the present invention is limited only by the claims that follow.

What is claimed is:

1. A method for voice over Internet Protocol (VOIP) service, comprising:
connecting a VOIP device to a network and saving a network address of the device;
subscribing to a telephony service from a VOIP provider (VP) for use with the VOIP device;
detecting for a change in the network address of the device,
wherein if a change in the network address has occurred, then transmitting a message to the device that notifies a user to confirm whether the device has changed a physical location;
providing the user a mechanism to contact the VOIP provider with updated physical location information if the device has changed physical location; and
blocking calls at the device if the user fails to provide the VP with the updated physical location information.

2. The method of claim 1, further comprising:
detecting a power recycle of the VOIP device as a precondition to detecting a change in the network address of the device.

3. The method of claim 2, wherein if a change in the network address has not occurred after a power recycle, then taking no action to transmit the message and taking no action to block the calls from the device.

4. The method of claim 1, wherein the transmitting the message comprises playing an announcement to the user that the location information needs to be updated.

5. The method of claim 1, wherein the transmitting a message comprises playing one of a ringing tone, network busy, and proprietary tone on the VOIP device.

6. The method of claim 1, wherein the providing the user a mechanism to contact the VOIP provider comprises providing one of a dedicated key and a soft key on the device.

7. The method of claim 1, further comprising:
providing the user a mechanism to notify the VOIP provider that the location information currently held by the provider has not changed.

8. The method of claim 1, wherein the providing the user a mechanism to contact the VOIP provider comprises providing an Internet Web site that allows the user to enter updated location information or to enter that the location has not changed.

9. The method of claim 1, wherein the transmitting a message comprises transmitting a text character message and displaying the message in text on a screen of the VOIP device.

10. A system for voice over Internet Protocol (VOIP) service, comprising:
a VOIP device connected to a network having a processor and memory that saves the device's network address to the memory;
a VOIP provider (VP) connected to the network, wherein the VOIP device is used for a subscription telephony service with the VP;
detecting for a change in the network address of the device,
wherein the VOIP device detects a change in the network address, then the device transmits a message that notifies a user of the device to confirm whether the device has changed a physical location; and
a mechanism on the VOIP device to contact the VOIP provider with updated physical location information if the device has changed physical location,
wherein one of the device and VP blocks calls at the device if the user fails to provide the VP with the updated physical location information.

11. The system of claim 10, wherein the VOIP device detects a power recycle of as a precondition to detecting a change in the network address of the device.

12. The system of claim 11, wherein if a change in the network address has not occurred after a power recycle, then the VOIP device takes no action to transmit the message and takes no action to block the calls from the device.

13. The system of claim 10, wherein the VOIP device is a media gateway and the message is transmitted to an IP phone connected to the media gateway.

14. The system of claim 10, wherein the VOIP device transmits the message by playing one of an announcement, a ringing tone, network busy, and proprietary tone on the VOIP device.

15. The system of claim 10, wherein the VOIP device provides the user a mechanism to contact the VOIP provider with one of a dedicated key and a soft key on the device.

16. The system of claim 10, wherein the VOIP device transmits a message by transmitting a text character message and displaying the message in text on a screen of the VOIP device.

17. A system for providing E911 location data for subscribers of a Voice Over Internet Protocol (VOIP) telephony service, comprising:
a VOIP device, connected to a network over which the device is subscribed to the VOIP service using a VOIP service provider (VP),
wherein the device detects one of a power recycle and a change of a network address of the device and notifies a user of the device that a geographic location information of the device needs to be updated with the VP.

18. The system of claim 17, wherein the VOIP device comprises a mechanism for the user to respond to the notification for one of a verification and change of a geographic location information.

19. The system of claim 17, wherein the VOIP device comprises a media gateway that transmits the notification to a telephone handset.

20. The system of claim 17, wherein the VOIP device is an IP phone.
